(19) United States
(12) Patent Application Publication
(10) Pub. No.: US 2015/0095002 A1
(43) Pub. Date: Apr. 2, 2015

(54) ELECTRONIC DEVICE AND MEASURING METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); HENG ZHANG, Shenzhen (CN)

(21) Appl. No.: 14/491,176

(22) Filed: Sep. 19, 2014

(30) Foreign Application Priority Data
Sep. 27, 2013 (CN) 2013104520299

(51) Int. Cl. G06F 17/50

(52) U.S. Cl. CPC G06F 17/5009
USPC 703/6

(57) ABSTRACT

An electronic device having a processing unit and a storage device is disclosed. The storage device stores a plurality of instructions. When the plurality of instructions are executed by the processing unit, the processing unit controls a scanning device coupled to the electronic device to scan an object for a point cloud, and converts the point cloud into a mesh model. Then, the processing unit selects a measured point from the mesh model, computes first coordinates of the measured point based on the mesh model, and simulates a motion path of a testing unit based on the first coordinates of the measured point.

### CROSS-REFERENCE TO RELATED APPLICATIONS

This application claims priority to Chinese Patent Application No. 201310452029.9 filed on Sep. 27, 2013 in the China Intellectual Property Office, the contents of which are incorporated by reference herein.

### FIELD

The subject matter herein generally relates to an electronic device, and particularly to an electronic device including a measuring system and a measuring method executed by the electronic device for measuring an object.

### BACKGROUND

When a measuring device is used to measure a point on an object with a probe, the operation of the probe can be an arduous task in the measuring process.

### BRIEF DESCRIPTION OF THE DRAWINGS

Implementations of the present technology will now be described, by way of example only, with reference to the attached figures, wherein:

FIG. 1 is a block diagram of one embodiment of an electronic device including a measuring system.

FIG. 2 illustrates a flowchart of one embodiment of a measuring method for the electronic device of FIG. 1.

FIG. 3 is a diagram of one embodiment of a plurality of triangle meshes formed by a triangle mesh model.

FIG. 4 is a diagram of one embodiment of a motion path of a testing unit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

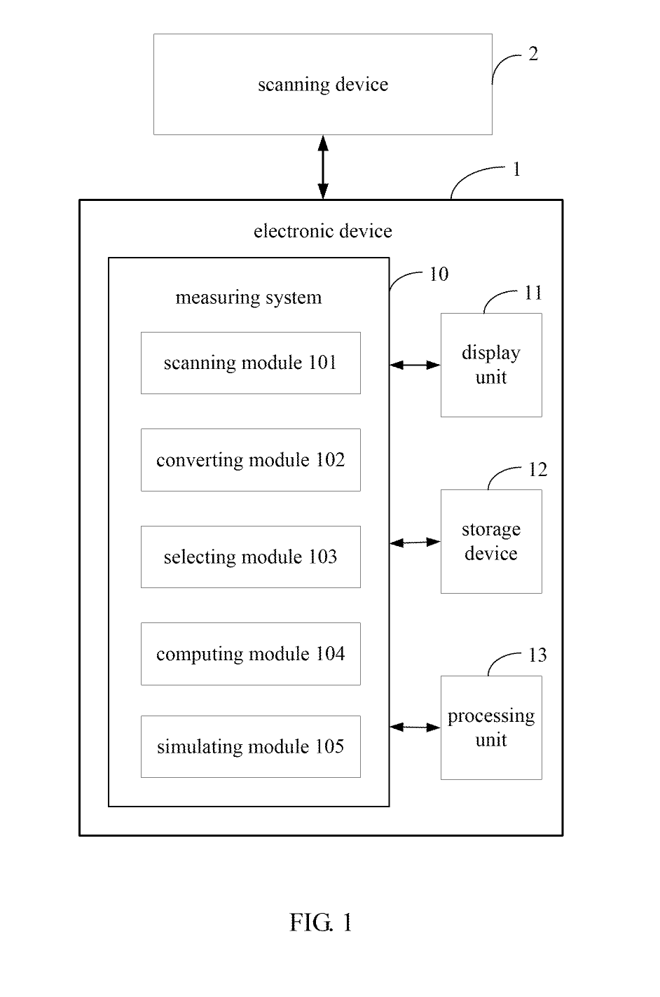

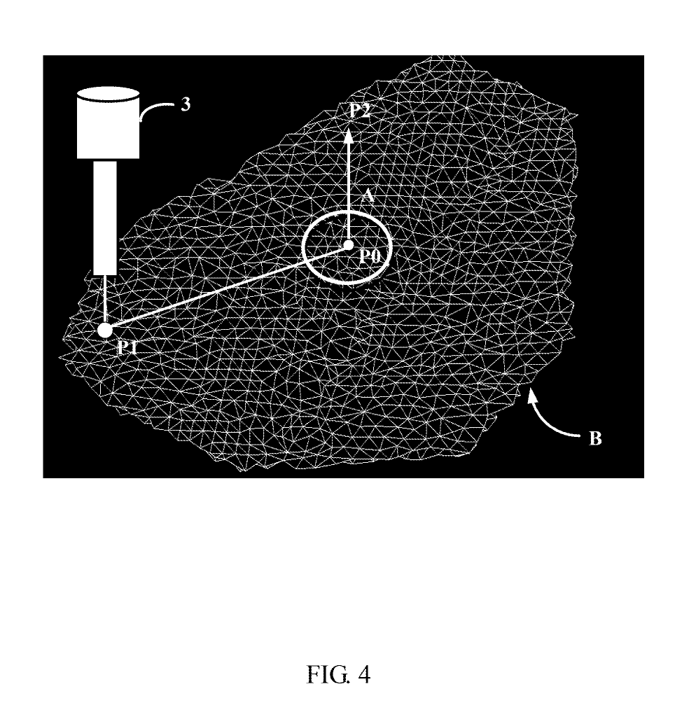

FIG. 1 illustrates an embodiment of an electronic device 1 including a measuring system 10. In the embodiment, the electronic device 1 can include a display unit 11, a storage device 12, and a processing unit 13, and the electronic device 1 can be coupled to a scanning device 2 in FIG. 1 and a testing unit 3 in FIG. 4. The storage device 12 can store a plurality of instructions. When the plurality of instructions are executed by the processing unit 13, the processing unit 13 controls a scanning device 2 coupled to the electronic device 1 to scan an object for a point cloud, converts the point cloud into a mesh model, selects a measured point from the mesh model, computes first coordinates of the measured point based on the mesh model, and simulates a motion path of a testing unit 3 based on the first coordinates of the measured point.

When the processing unit 13 controls the scanning device 2 to scan the object for the point cloud, the scanning device 2 can scan a whole surface of the object to generate the point cloud. Thus, the processing unit 13 can receive the point cloud from the scanning device 2. Then, the processing unit 13 can convert the point cloud into the mesh model using a triangle mesh model, and the mesh model can include a plurality of triangle meshes.

When a measured point is selected from the mesh of the point cloud, the processing unit 13 can generate a ray passing through the measured point along a first normal line of the display unit 11. The processing unit 13 further obtains an intersection line between the ray and the mesh model, and determines an external vertex of the intersection line at which the ray intersects with an external surface of the mesh model. Thus, the processing unit 13 can determine second coordinates of the measured point based on the external vertex.

The processing unit 13 determines a plurality of neighboring meshes adjacent to the measured point from the plurality of triangle meshes based on a first specific algorithm, such as a bounding box algorithm. The processing unit 13 further computes a plurality of median points in the plurality of neighboring meshes based on the second coordinates. Then, the processing unit 13 computes a fitting plane by using the plurality of median points, and computes the first coordinates of the measured point and a second normal line of the fitting plane by using the fitting plane based on a second specific algorithm, such as least squares method and quasi-Newton iterative algorithm.

When the first coordinates of the measured point is generated by the processing unit 13, the processing unit 13 measures third coordinates of the testing unit 3 for simulating the motion path of the testing unit 3 based on the first coordinates and the third coordinates. The testing unit 3 is coupled to the electronic device 1, and can be controlled by the electronic device 1. Then, the processing unit 13 can determine whether the motion path intersects with the mesh model. If there is an intersection between the motion path and the mesh model, the testing unit 3 will collide with the object while being moved along the motion path. Thus, the processing unit 13 can receive a selection to select another measured point. If there is no intersection between the motion path and the mesh model, the testing unit 3 will not collide with the object while being moved along the motion path. Therefore, the processing unit 13 can control the testing unit 3 to measure the measured point, and show real coordinates of the measured point, the second normal line, and the motion path of the testing unit 3 on the display unit 11.

The display unit 11 can display the measured information. Thus, the display unit 11 can comprise a display device using liquid crystal display (LCD) technology, or light emitting polymer display (LPD) technology, although other display technologies can be used in other embodiments.

The storage device 12 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other forms of electronic, electromagnetic or optical recording medium. In one embodiment, the storage device 12 can include interfaces that can access the aforementioned computer readable storage medium to enable the electronic device 1 to connect and access such computer readable storage medium. In another embodiment, the storage device 12 can include network accessing device to enable the electronic device 1 to connect and access data stored in a remote server or a network-attached storage.

The processing unit 13 can be a processor, a central processing unit (CPU), a graphic processing unit (GPU), a system on chip (SoC), a field-programmable gate array (FPGA), or a controller for executing the program instruction in the storage device 12 which can be static RAM (SRAM), dynamic RAM (DRAM), EPROM, EEPROM, flash memory or other types of computer memory. The processing unit 13 can further include an embedded system or an application specific integrated circuit (ASIC) having embedded program instructions.

In one embodiment, the electronic device 1 can be a server, a desktop computer, a laptop computer, or other electronic devices. Moreover, FIG. 1 illustrates only one example of an electronic device 1, that can include more or fewer components than illustrated, or have a different configuration of the various components in other embodiments.

In one embodiment, the electronic device 1 is coupled to the scanning device 2. The scanning device 2 can be a non-contact active scanner or a non-contact passive scanner. In one embodiment, the scanning device 2 can be an optical three dimensional scanner with an optical beam. The optical beam includes a light, a laser, an ultraviolet ray and an infrared ray. In one embodiment, the scanning device 2 can be a scanner with a charge-coupled device (CCD) to scan the whole surface of the object.

In at least one embodiment, the measuring system 10 can include one or more modules, for example, a scanning module 101, a converting module 102, a selecting module 103, a computing module 104, and a simulating module 105. A “module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage devices. Some non-limiting examples of non-transitory computer-readable medium include CDs, DVDs, BLU-RAY, flash memory, and hard disk drives.

The scanning module 101 can scan the object to generate the point cloud. The converting module 102 can convert the point cloud into the mesh model including the plurality of triangle meshes. The selecting module 103 can select the measured point from the mesh model. Then, the computing module 104 can determine the second coordinates of the measured point based on the intersection line between the ray passing through the measured point and the mesh model, and determines the plurality of neighboring meshes adjacent to the measured point from the plurality of triangle meshes. Further, the computing module 104 can compute the fitting plane based on the neighboring meshes, and generate the first coordinates of the measured point and the second normal line of the fitting plane based on the fitting plane. The simulating module 105 can simulate the motion path of the testing unit 3 based on the first coordinates of the measured point and the third coordinates of the testing unit 3, and determine whether the motion path intersects with the mesh model.

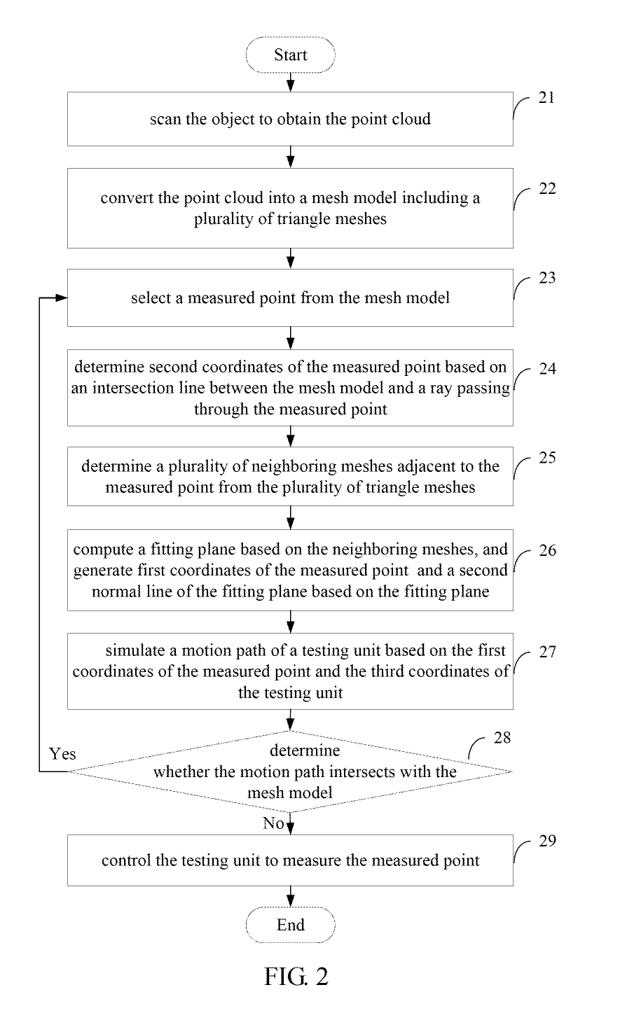

FIG. 2 illustrates a flowchart in accordance with an example embodiment. The example method is provided by way of example, as there are a variety of ways to carry out the method. The method described below can be carried out using the configuration illustrated in FIG. 1, for example, and various elements of these figures are referenced in explaining example method. Each block shown in FIG. 2 represents one or more processes, methods or subroutines, carried out in the example method. Furthermore, the order of blocks is illustrative only and can change according to the present disclosure. Additional blocks can be added or fewer blocks can be utilized, without departing from this disclosure. The example method can begin at block 21.

At block 21, the scanning module 101 scans an object to generate a point cloud. In the embodiment, the object is scanned by the scanning device 2 coupled to the electronic device 1, and the point cloud is transmitted from the scanning device 2 to the electronic device 1. In one embodiment, the scanning module 101 controls the scanning device 2 to scan the object for the point cloud.

In one embodiment, the scanning device 2 can be an optical three dimensional scanner. The scanning module 101 can scan the whole surface of the object using an optical beam to generate the point cloud. The optical beam includes a light, a laser beam, an ultraviolet ray and an infrared ray. In one embodiment, the point cloud is a set of data points generated by scanning the whole surface of the object, and the point cloud can exhibit the external surface of the object.

At block 22, the converting module 102 converts the point cloud into a mesh model. In one embodiment, the point cloud is converted into the mesh model using a triangle mesh model, and the mesh model includes a plurality of triangle meshes.

In one embodiment, the point cloud can be converted into the plurality of triangle meshes using the triangle mesh module based on at least one rule. The at least one rule can include a first rule that no point in the point cloud is inside the circumscribed circles of the triangle meshes, and a second rule that curvatures of neighboring triangle mesh are similar to each other. When a triangle mesh is formed based on the first rule, the triangle mesh can be examined based on the second rule. In one embodiment, a vector of the triangle mesh can be computed for comparing with another vector of the neighboring triangle mesh. If an angle between the vectors of the triangle mesh and the neighboring triangle mesh, the triangle mesh will be discarded and reconstructed with other points to generate a new triangle mesh.

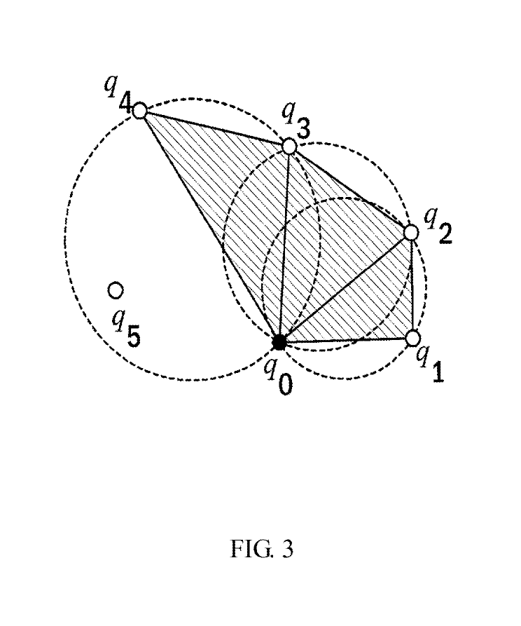

FIG. 3 illustrates that the converting module 102 can select a point in the point cloud as a first point, such as point q₀. Then, the converting module 102 selects a point near the first point as a second point, such as point q₁. In one embodiment, a threshold of a distant between the first point and the second point can be preset by a user. In one embodiment, the converting module 102 can select the nearest point for the first point. The converting module 102 connects the first point q₀ and the second point q₁, and selects a third point, such as point q₂. When the converting module 102 selects the third point, the converting module 102 prevents other points in the point cloud from being inside the circumscribed circle of the triangle mesh formed by the points q₀, q₁, and q₂. Therefore, since the point q₅ is inside the circumscribed circle of the triangle mesh formed by the points q₀, q₃, and q₄, the triangle mesh formed by the points q₀, q₃, and q₄, is incorrect and can be discarded and reconstructed with other points in the point cloud, such as point q₅.

At block 23, the selecting module 103 selects a measured point from the mesh model. In one embodiment, the user can select a point to be measured, and then the selecting module 103 receives the point to be measured and selects the point to be measured as the measured point. In one embodiment, the selecting module 103 can generate a ray passing through the measured point along a first normal line of the display unit 11. FIG. 4 illustrates that the selecting module 103 can select a point P₀ on the mesh B of the point cloud as the measured point, and generate a ray passing through the point P₀ along a first normal line of the display unit 11.

At block 24, the computing module 104 determines second coordinates of the measured point based on an intersection line between the ray and the mesh model. In one embodiment, the computing module 104 obtains an intersection line between the ray and the mesh model, and then determines second coordinates of the measured point based on the intersection line.

In one embodiment, since there are many intersecting points between the mesh model and the ray in a forward direction and between the mesh model and the ray in a backward direction, the computing module 104 obtains an intersection line between the ray and the mesh model based on the intersecting points. In addition, a ray is externally generated from a point on the surface of the mesh, intersecting with the mesh only at the point on the surface of the mesh. Therefore, the computing module 104 can obtain an external vertex of the intersection line at which the ray intersects with a surface of the mesh model. The external vertex can be regarded as the measured point by the computing module 104.

In one embodiment, the computing module 104 can generate fourth coordinates of the external vertex, and set the fourth coordinates as the second coordinates of the measured point. In the embodiment, the fourth coordinates of the external vertex can be generated based on a default setting defined by the user.

At block 25, the computing module 104 determines a plurality of neighboring meshes adjacent to the measured point from the plurality of triangle meshes. In one embodiment, the computing module 104 can determine all of the neighboring meshes adjacent to the measured point based on a first specific algorithm. The first specific algorithm can be a bounding box algorithm. The mesh model can be divided into a plurality of small boxes based on the bounding box algorithm. Each of the small boxes can be assigned a specific number so that the plurality of neighboring meshes adjacent to the measured point can be easily obtained based on the specific numbers. FIG. 4 illustrates that the triangles in a circle A with a center at the measured point P₀ can be regarded as the plurality of neighboring meshes adjacent to the measured point P₀.

At block 26, the computing module 104 computes a fitting plane based on the neighboring meshes, and generates the first coordinates of the measured point and a second normal line of the fitting plane based on the fitting plane. In one embodiment, the computing module 104 can compute a plurality of median points in the plurality of neighboring meshes based on the second coordinates of the measured point, and compute the fitting plane based on the plurality of median points. Then, the computing module 104 can compute the first coordinates of the measured point and the second normal line based on the fitting plane.

In one embodiment, the computing module 104 can compute the fitting plane and the second normal line based on a second specific algorithm. In one embodiment, the second specific algorithm can include the least squares method and the quasi-Newton iterative algorithm. Thus, the computing module 104 can compute the fitting plane based on the least squares method, wherein a sum of squares of residuals between the plurality of median points and the fitting plane is a minimum. In one embodiment, the computing module 104 can generate the second normal line P₀P₂ of the fitting plane based on the fitting plane. In one embodiment, the computing module 104 can generate the first coordinates of the measured point based on the quasi-Newton iterative algorithm. In one embodiment, the quasi-Newton iterative algorithm can be executed based on a function, f(x)=^{Min}{square root over (Σ({square root over (x2−x1)²+(y2−y1)²+(z2−z1)²))}²/n,)} wherein (x1, y1, z1) is the coordinates of the plurality of median points, (x2, y2, z2) is fifth coordinates of a center point on the fitting plane, and n is the number of the median points. In one embodiment, the computing module 104 can regard the fifth coordinates as the first coordinates of the measured point.

In one embodiment, blocks 24-26 can be combined to be executed by the computing module 104. When the measured point is selected by the selecting module 103, the computing module 104 can compute the first coordinates of the measured point based on the mesh model according to the method in the blocks 24-26 or other methods.

At block 27, the simulating module 105 simulates a motion path of the testing unit 3 based on the first coordinates of the measured point and the third coordinates of the testing unit 3. In one embodiment, the simulating module 105 measures the third coordinates of the testing unit 3, and simulates the motion path based on the first coordinates and the third coordinates.

FIG. 4 illustrates that the testing unit 3 is located at the point P₁, and the measured point is located at the point P₀. The simulating module 105 simulates the motion path P₀P₁ based on the first coordinates of the point P₀ and the third coordinates of the point P₁.

At block 28, the simulating module 105 determines whether the motion path intersects with the mesh model. In one embodiment, if the motion path intersects with the mesh model, the procedure goes to block 23. In one embodiment, if the motion path does not intersect with the mesh model, the procedure goes to block 29.

In one embodiment, the simulating module 105 searches an intersection between the motion path and the mesh model for determining whether the testing unit 3 will collide with the object while being moved along the motion path. If there is an intersection between the motion path and the mesh model, the testing unit 3 will collide with the object while being moved along the motion path. Thus, the selecting module 103 can select another point. If there is no intersection between the motion path and the mesh model, the testing unit 3 will not collide with the object while being moved along the motion path.

In one embodiment, if there is an intersection between the motion path and the mesh model, the electronic device 1 can adjust some parameters, such as the position of the testing unit 3, to measure the measured point.

At block 29, the electronic device 1 controls the testing unit 3 to measure the measured point. In one embodiment, the electronic device 1 can show real coordinates of the measured point measured by the testing unit 3, the second normal line, and the motion path of the testing unit 3 on the display unit 11. Thus, the user can obtain measured information of the measured point on the surface of the object.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. An electronic device comprising:
a processing unit; and
a storage device that stores a plurality of instructions, when executed by the processing unit, causes the processing unit to:
control a scanning device coupled to the electronic device to scan an object for a point cloud;
convert the point cloud into a mesh model;
select a measured point from the mesh model;
compute first coordinates of the measured point based on the mesh model; and
simulate a motion path of a testing unit based on the first coordinates of the measured point.

2. The electronic device according to claim 1, wherein the point cloud is converted into the mesh model using a triangle mesh model.

3. The electronic device according to claim 1, wherein the plurality of instructions further cause the processing unit to:
generate a ray passing through the measured point along a first normal line of a display unit of the electronic device;
obtain an intersection line between the ray and the mesh model; and
determine second coordinates of the measured point based on the intersection line.

4. The electronic device according to claim 3, wherein the second coordinates of the measured point are determined based on an external vertex of the intersection line at which the ray intersects with a surface of the mesh model.

5. The electronic device according to claim 3, wherein the plurality of instructions further cause the processing unit to:
determine a plurality of neighboring meshes adjacent to the measured point from the mesh model including a plurality of triangle meshes;
compute a plurality of median points in the plurality of neighboring meshes based on the second coordinates;
compute a fitting plane based on the plurality of median points; and
generate the first coordinates of the measured point and a second normal line of the fitting plane based on the fitting plane.

6. The electronic device according to claim 1, wherein the plurality of instructions further cause the processing unit to:
measure third coordinates of the testing unit;
simulate the motion path based on the first coordinates and the third coordinates;
determine whether the motion path intersects with the mesh model; and
control the testing unit to measure the measured point when the motion path does not intersect with the mesh model.

7. A measuring method for measuring an object in three dimensions executed by an electronic device, the method comprising:
receiving a point cloud of the object;
converting the point cloud into a mesh model;
receiving a measured point selected from the mesh model;
computing first coordinates of the measured point based on the mesh model; and
simulating a motion path of a testing unit based on the first coordinates of the measured point.

8. The method according to claim 7, wherein the object is scanned to generate the point cloud by a scanning device coupled to the electronic device, and the point cloud is transmitted from the scanning device.

9. The method according to claim 7, comprising:
generating a ray passing through the measured point along a first normal line of a
display unit of the electronic device;
obtaining an intersection line between the ray and the mesh model; and
determining second coordinates of the measured point based on the intersection line.

10. The method according to claim 9, wherein the second coordinates of the measured point are determined based on an external vertex of the intersection line at which the ray intersects with a surface of the mesh model.

11. The method according to claim 9, comprising:
determining a plurality of neighboring meshes adjacent to the measured point from the mesh model including a plurality of triangle meshes;
computing a plurality of median points in the plurality of neighboring meshes based on the second coordinates;
computing a fitting plane based on the plurality of median points; and
generating the first coordinates of the measured point and a second normal line of the fitting plane based on the fitting plane.

12. The method according to claim 7, comprising:
measuring third coordinates of the testing unit;
simulating the motion path based on the first coordinates and the third coordinates;
determining whether the motion path intersects with the mesh model; and
controlling the testing unit to measure the measured point when the motion path does not intersect with the mesh model.

13. An electronic device comprising:
a scanning device; and
one or more processors communicatively coupled to the scanning device and configured to receive executable instructions to:
scan an object for a point cloud;
convert the point cloud into a mesh model;
select a measured point from the mesh model;
compute a first set of coordinates of the measured point; and
simulate a motion path of a testing unit based on the first set of coordinates.
